(19) United States
(12) Patent Application Publication
(10) Pub. No.: US 2019/0219766 A1
(43) Pub. Date: Jul. 18, 2019

(54) OPTICAL CONNECTION STRUCTURE AND OPTICAL MODULE

(71) Applicant: FURUKAWA ELECTRIC CO., LTD., Tokyo (JP)

(72) Inventors: Kengo Watanabe, Tokyo (JP); Kazunori Mukasa, Tokyo (JP); Tsunetoshi Saito, Tokyo (JP); Yoshiki Nomura, Tokyo (JP)

(21) Appl. No.: 16/361,629

(22) Filed: Mar. 22, 2019

Related U.S. Application Data
(63) Continuation of application No. PCT/JP2017/035474, filed on Sep. 29, 2017.

(30) Foreign Application Priority Data
Sep. 29, 2016 (JP) 2016-191454

(51) Int. Cl. G02B 6/26

(52) U.S. Cl. CPC G02B 6/262; G02B 6/032

(57) ABSTRACT

A tapered waveguide is optically connected to an end surface of an optical fiber bundle part, and has a tapered part that changes in outside diameter in a tapered shape. The fiber bundle part is optically connected to the end surface of the large-diameter side of the waveguide. The entire waveguide has a substantially uniform index of refraction. A delivery fiber is optically connected to the end surface on the small-diameter side of the waveguide. As with the fiber bundle part the delivery fiber passes through a hole in a capillary and is affixed. The capillaries are each affixed to a retaining member such that the fiber bundle part, the waveguide, and the delivery fiber are disposed on the same axis and optically connected. The waveguide is retained in a state floating from the retaining member, and the outside surface of the waveguide is not in contact with the retaining member.

### TECHNICAL FIELD

The present disclosure relates to an optical connection structure for a delivery fiber that delivers high power light of, for example, a fiber laser, and the like.

### BACKGROUND

To optically couple light from a plurality of bundled optical fibers with a delivery fiber, it is required that a region including all the optical fibers is to be narrowed down to a smaller region than a core of the delivery fiber. Thus, a tapered waveguide is optically connected between the bundle of the optical fibers and the delivery fiber (Japanese Unexamined Patent Application Publication No. 2008-191580 (JP-A-2008-191580), for example).

An end part of such a tapered waveguide has a core diameter that is larger than a diameter of a circle that includes all the incident light from the optical fibers, and the other end part of the tapered waveguide has a core diameter that is smaller than a core diameter of a delivery fiber. By using such a tapered waveguide whose outer diameter changes in a tapered shape, light from a plurality of optical fibers can be optically coupled with a delivery fiber.

Here, efficiency of optical coupling of a tapered waveguide with a delivery fiber is to be considered. θᵢₙ is an angle of incident of light entering into a tapered waveguide, θₜₐₚₑᵣ is an angle of taper of the tapered waveguide, and θₒᵤₜ is an angle of light emitted from the tapered waveguide. In this case, θᵢₙ<θₒᵤₜ and, to prevent leaking of light at the tapered part, it is required that θₒᵤₜ+θₜₐₚₑᵣ taper does not exceed θₘₐₓ(=arcsin (NAₜₐₚₑᵣ)) which is defined by a numerical aperture of the tapered waveguide NAₜₐₚₑᵣ. That is, it is required to satisfy a formula (1):

θₒᵤₜ+θₜₐₚₑᵣ≤arcsin(NAₜₐₚₑᵣ) (1).

Also, to prevent leaking of transmitted light at the delivery fiber, it is required that θₘ does not exceed θₘₐₓ(=arcsin (NA_{delivery})), which is defined by a numerical aperture of the delivery fiber NA_{delivery}. That is, it is required to satisfy a formula (2):

θₒᵤₜarcsin(NA_{delivery}) (2).

Here, to introduce light of maximum power into a delivery fiber whose core diameter and the numerical aperture are already known, it is required to increase the core diameter of an entrance of the tapered waveguide until

θₒᵤₜ=arcsin(NA_{delivery}) (3)

is satisfied under a condition of the formula (2), where the transmitted light never leaks at the delivery fiber.

On the other hand, since it is required not to leak light at the tapered waveguide, substituting the formula (3) into the formula (1) gives

NAₜₐₚₑᵣ≥sin[arcsin(NA_{delivery})+θₜₐₚₑᵣ] (4).

Since θₜₐₚₑᵣ (approximately 1^{°}, for example) is sufficiently smaller than θₒᵤₜ (10^{°}-30^{°}, for example), according to the formula (4), NAₜₐₚₑᵣ is to be slightly larger than NA_{delivery} to introduce maximum power light into the delivery fiber.

Here, a common tapered waveguide using a pre-existing silica-based waveguide structure has NAₜₐₚₑᵣ of approximately 0.35 (difference in non-refractive index is 3%), and, even if a resin with low refractive index is used as a clad, NAₜₐₚₑᵣ of only approximately 0.5 can be achieved. Thus, if the pre-existing silica-based tapered waveguide is used, even with the sufficiently large numerical aperture of the delivery fiber, the difference of the refractive index between the core and the clad is not enough and it is impossible to couple light with the delivery fiber to the limit.

The present disclosure was made in view of such problems. Its object is to provide an optical connection structure and the like that can efficiently introduce light into a delivery fiber.

### SUMMARY OF THE DISCLOSURE

To achieve the above object, a first embodiment is an optical connection structure including a tapered waveguide having a tapered part whose outer diameter changes in a tapered shape, an optical fiber bundle part, which is formed of a plurality of optical fibers that are assembled together and is optically connected to an end surface on a large-diameter side of the tapered waveguide, and a delivery fiber that is optically connected with an end surface on a small-diameter side of the tapered waveguide. The optical fiber bundle part and the delivery fiber are fixed to capillaries respectively, wherein each of the capillaries is fixed to a retaining member and an outer side face of the tapered waveguide is not in contact with the retaining member.

The retaining member is a substantially cylindrical member and may envelop all circumference of the outer side face of the tapered waveguide with a space therebetween.

The optical fiber bundle part may be in a bundle structure in which a plurality of optical fibers are bundled.

The entire tapered waveguide may be formed with a substantially uniform refractive index.

An air clad may be provided on at least a part of an interior of the tapered waveguide.

The tapered waveguide may include a core and a clad enveloping the core.

The tapered waveguide may have a graded index type refractive index profile.

The delivery fiber may be a hollow core fiber.

The hollow core fiber may be a hollow core PBGF (Photonic Band Gap Fiber).

The hollow core PBGF may be a Kagome fiber.

A straight part having a predetermined length and a substantially uniform diameter may be formed in proximity of the small-diameter side of the tapered waveguide, and a part of the straight part may be inserted into the hollow core fiber.

The tapered waveguide and the delivery fiber may be optically connected with an intermediary fiber therebetween.

The delivery fiber may be a hollow core fiber and a part of the intermediary fiber may be inserted into the hollow core fiber.

A second embodiment is an optical module including a tapered waveguide having a tapered part whose outer diameter changes in a tapered shape, an optical fiber bundle part, which is formed of a plurality of optical fibers that are assembled together and is optically connected to an end surface on a large-diameter side of the tapered waveguide, a delivery fiber that is optically connected with an end surface on a small-diameter side of the tapered waveguide, and a housing that accommodates the tapered waveguide. The optical fiber bundle part and the delivery fiber are fixed to capillaries respectively, wherein each of the capillaries is fixed to the housing, an outer side face of the tapered waveguide is not in contact with the housing, and a fluid is enclosed inside the housing or the housing is in a vacuum state inside.

A fluid channel may be connected to the housing, allowing fluid to circulate inside the housing.

A holding member may hold each of the capillaries and the holding member may be joined to an inner face of the housing.

The present embodiments can provide an optical connection structure and the like that can efficiently introduce light into a delivery fiber.

### BRIEF DESCRIPTION OF DRAWINGS

FIG. 1 is a schematic view showing an optical connection structure 1.

FIG. 2A is a cross sectional view of the optical connection structure 1 taken vertically to a longitudinal direction of the optical connection structure 1 along A-A line in FIG. 1.

FIG. 2B is a cross sectional view of the optical connection structure 1 taken vertically to the longitudinal direction of the optical connection structure 1 along B-B line in FIG. 1.

FIG. 2C is a cross sectional view of the optical connection structure 1 taken vertically to the longitudinal direction of the optical connection structure 1 along C-C line in FIG. 1.

FIG. 3A is a view showing another embodiment of an optical fiber bundle part 3.

FIG. 3B is a view showing another embodiment of the optical fiber bundle part 3.

FIG. 4A is a view showing an embodiment of a delivery fiber 7.

FIG. 4B is a view showing an embodiment of the delivery fiber 7.

FIG. 5A is a view showing an embodiment of an optical connection part between a tapered waveguide 5 and the delivery fiber 7.

FIG. 5B is a view showing an embodiment of the optical connection part between the tapered waveguide 5 and the delivery fiber 7.

FIG. 5C is a view showing an embodiment of the optical connection part between the tapered waveguide 5 and the delivery fiber 7.

FIG. 6A is a side view of a tapered waveguide 5a.

FIG. 6B is a cross sectional view taken along E-E line in FIG. 6A.

FIG. 7A is a side view of a tapered waveguide 5b.

FIG. 7B is a cross sectional view taken along F-F line in FIG. 7A.

FIG. 8 is a schematic view showing an optical connection structure 1a.

FIG. 9A is a cross sectional view of the optical connection structure 1a taken vertically to a longitudinal direction of the optical connection structure 1a along G-G line in FIG. 8.

FIG. 9B is a cross sectional view of the optical connection structure 1a taken vertically to the longitudinal direction of the optical connection structure 1a along H-H line in FIG. 8.

FIG. 9C is a cross sectional view of the optical connection structure 1a taken vertically to the longitudinal direction of the optical connection structure 1a along I-I line in FIG. 8.

FIG. 10A is a schematic view showing an optical connection structure 1b.

FIG. 10B is a schematic view showing an optical connection structure 1c.

FIG. 10C is a schematic view showing an optical connection structure 1d.

FIG. 11A is a view showing another embodiment of the optical connection part between the tapered waveguide 5 and the delivery fiber 7.

FIG. 11B is a view showing another embodiment of the optical connection part between the tapered waveguide 5 and the delivery fiber 7.

FIG. 12A is a schematic view showing an optical module 30.

FIG. 12B is a schematic view showing an optical module 30a.

### DETAILED DESCRIPTION

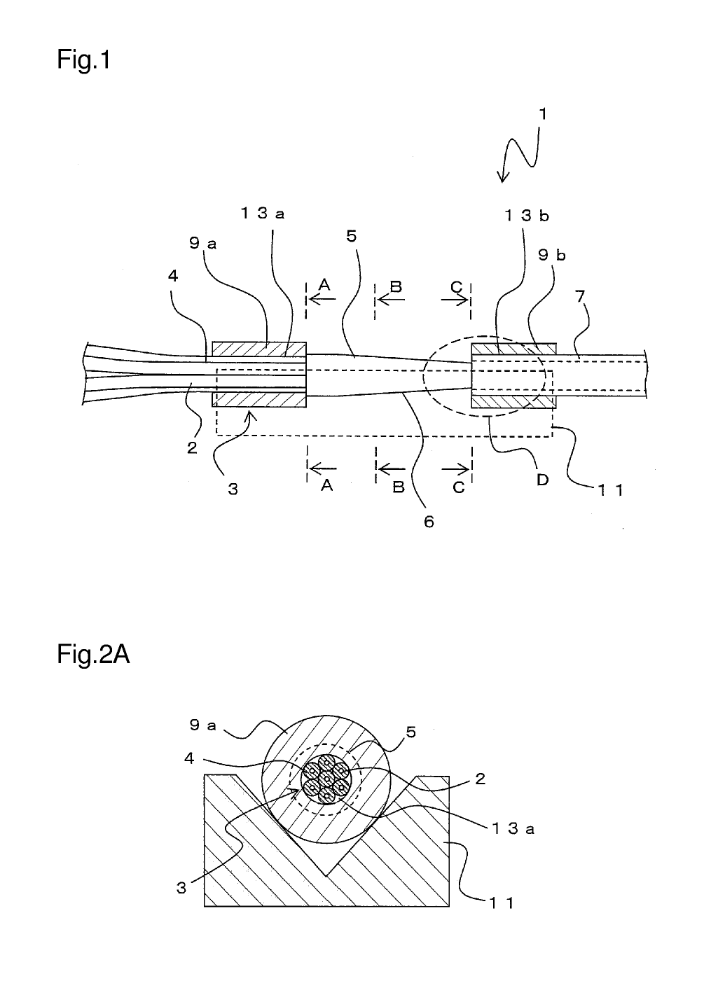

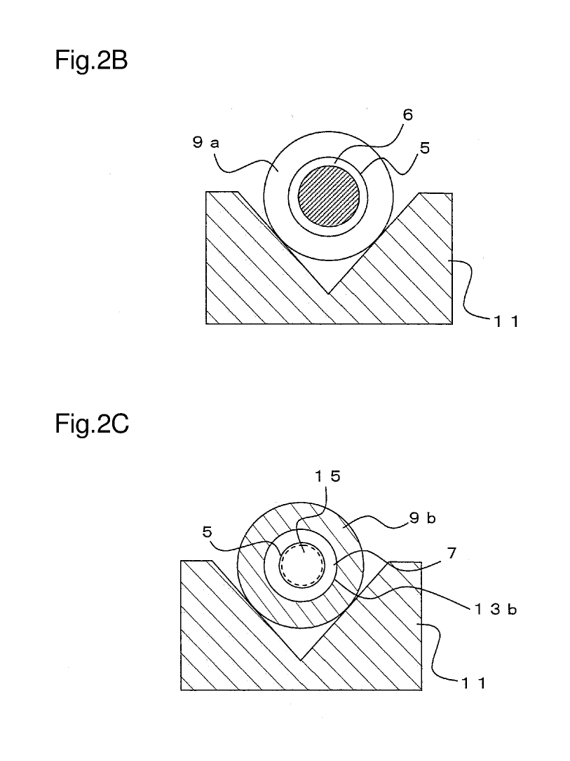

Hereinafter, an optical connection structure 1 will be described. FIG. 1 is a partial cross sectional view of the optical connection structure 1 taken parallel to an axial direction thereof. FIG. 2A is a cross sectional view taken along A-A line in FIG. 1, FIG. 2B is a cross sectional view taken along B-B line in FIG. 1, and FIG. 2C is a cross sectional view taken along C-C line in FIG. 1. FIG. 1 is also a perspective view of a retaining member 11. The optical connection structure 1 mainly includes an optical fiber bundle part 3, a tapered waveguide 5, a delivery fiber 7, capillaries 9a and 9b, a retaining member 11, and so on.

As shown in FIG. 2A, the optical fiber bundle part 3 is formed of a plurality of optical fibers 2 that are assembled together. The plurality of the optical fibers 2 are inserted into a hole 13a of the capillary 9a and fixed. That is, the optical fiber bundle part 3 is fixed to the capillary 9a. The hole 13a is in a circular shape, for example, and the optical fibers 2 are fixed inside the hole 13a in a substantially maximum dense arrangement so that adjacent optical fibers 2 are in contact with each other. That is, in the present embodiment, the optical fiber bundle part 3 is a bundle structure 4 in which the plurality of the optical fibers 2 are bundled. The capillary 9a may be a ferule of an optical connector.

The bundle structure 4 is formed by, for example, filling the hole 13a of the capillary 9a with an adhesive agent, sol-gel glass, or water glass, inserting and fixing the optical fibers 2 therein, and then polishing an end surface thereof. Silica glass, borosilicate glass, zirconia, metal, or the like are applicable as material for the capillary 9a.

The form of the bundle structure 4 is not limited to the illustrated example. For example, the number of the optical fibers 2 forming the bundle structure 4 is not limited: seven cores as shown in the illustration, or twelve, nineteen, or any other number of cores may be acceptable. Also, all the optical fibers 2 do not necessary have the same diameter: for example, the optical fiber 2 in the center may have a large outer diameter and the plurality of the optical fibers 2 having smaller diameters may be arranged therearound being in contact with each other.

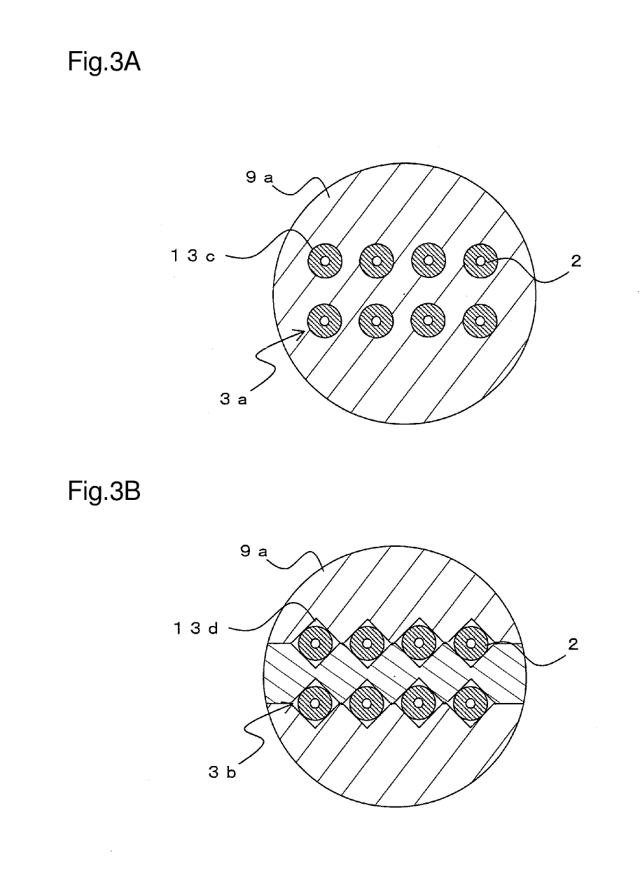

Also, the optical fiber bundle part 3 may not be in the bundle structure 4 in which the optical fibers 2 are directly bundled. For example, like an optical fiber bundle part 3a shown in FIG. 3A, a plurality of holes 13c are formed in the capillary 9a and the optical fiber 2 may be inserted into and fixed to each of the holes 13c.

Also, like an optical fiber bundle part 3b shown in FIG. 3B, the capillary 9a may be in a structure that is divided in a direction perpendicular to an axial direction thereof. In this case, a plurality of V grooves 13d are provided side by side at respective divided pieces. The optical fiber 2 is disposed in a space created by facing the V grooves 13d at the respective divided pieces to form an optical fiber array. In this case, facing the V grooves 13d at the respective divided pieces can provide the same effect as forming the plurality of the holes 13c. The form of the capillary 9a that fixes the optical fiber bundle part is not limited as long as the plurality of the optical fibers 2 are arranged and fixed as above.

The tapered waveguide 5 is optically connected to an end surface of the optical fiber bundle part 3. The tapered waveguide 5 includes a tapered part 6 whose outer diameter changes in a tapered shape. The optical fiber bundle part 3 is optically connected to the end surface on a large-diameter side of the tapered waveguide 5. An optical connection between the end surfaces of the optical fiber bundle part 3 and the tapered waveguide 5 may be, for example, by fusion or by bonding using an adhesive agent, water glass, or the like.

Here, in FIG. 2A, the outer diameter of the end surface of the tapered waveguide 5 facing the end surface of the optical fiber bundle part 3 is shown by a dotted line. The outer diameter on the large-diameter side of the tapered waveguide 5 is larger than a light existent region of the optical fiber bundle part 3. Thus, light emitting from each of the optical fibers 2 can be introduced into the tapered waveguide 5 without leaking.

The entire tapered waveguide 5 is formed with a substantially uniform refractive index. That is, the tapered waveguide 5 does not include materials or structures, such as a core and a clad, having different refractive indices, and is only formed of one material. The tapered waveguide 5 is formed of glass material such as quartz glass and borosilicate glass. In such a case, the tapered waveguide 5 can be manufactured by powder molding.

The delivery fiber 7 is optically connected to an end surface on a small-diameter side of the tapered waveguide 5. Similarly to the optical fiber bundle part 3, the delivery fiber 7 is inserted into and fixed to a hole 13b of a capillary 9b. The capillary 9b may have the same structure as the capillary 9a, for example.

Here, in FIG. 2C, the outer diameter of the end surface of the tapered waveguide 5 on an end surface of the delivery fiber 7 facing the same is shown by a dotted line. The outer diameter on the small-diameter side of the tapered waveguide 5 is smaller than a diameter of a core 15 of the delivery fiber 7. Thus, light emitting from the tapered waveguide 5 can be introduced into the core 15 of the delivery fiber 7 without leaking.

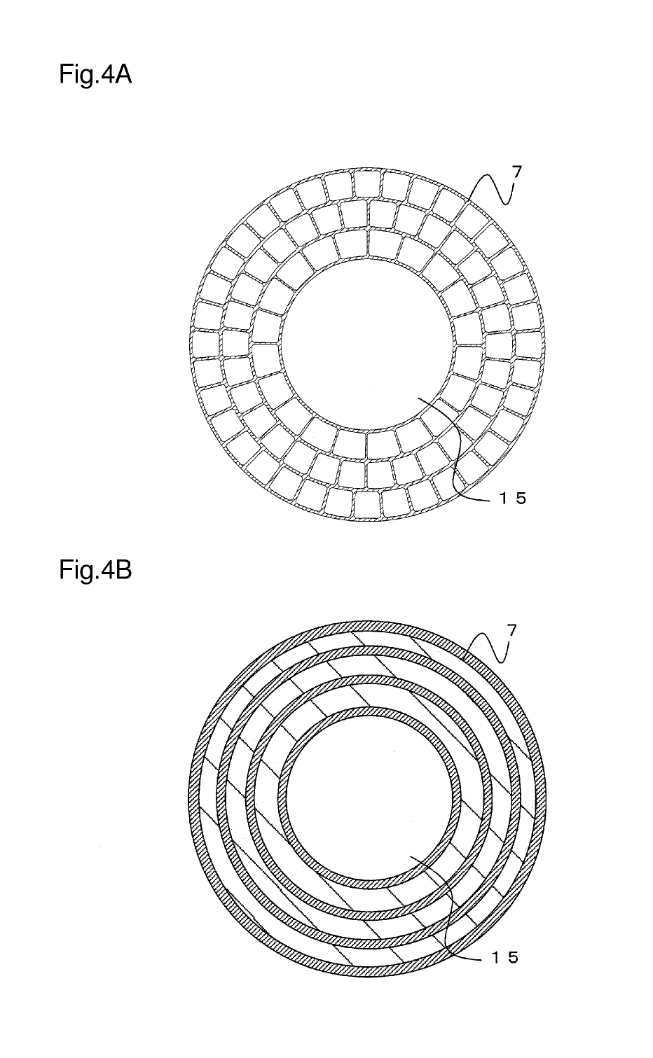

The delivery fiber 7 may be a common optical fiber in which a clad having a refractive index lower than that of the core 15 is formed on an outer circumference of the core 15, or may be a hollow core PBGF (Photonic Band Gap Fiber) shown in FIG. 4A. Alternatively, the delivery fiber 7 may be a hollow core Bragg fiber shown in FIG. 4B. The hollow core PBGF includes a plurality of separated air layers on the outer circumference of the hollow core 15. Also, in the hollow core Bragg fiber, high and low refractive indices are alternately and periodically arranged on the outer circumference of the hollow core. As the hollow core PBGF, a Kagome fiber having hollow lattice in Kagome lattice forms is frequently used. The structure of the Kagome fiber is described in, for example, OPTICS EXPRESS Vol. 21, No. 23, 28597, “Hypocycloid-shaped hollow-core photonic crystal fiber Part I: Arc curvature effect on confinement loss”. The Kagome fiber has a contrived design of separation, and is improved in single mode transmission capability and is capable of high peak power transmission.

Either type of the delivery fiber 7 has the hollow core 15, and using such a hollow core fiber enables to increase the numerical aperture of the delivery fiber 7 (for example, NA_{delivery}=0.7 or more). That is, light with more power can be transmitted. In the descriptions hereinafter, a case in which the delivery fiber 7 having the hollow core 15 will be described unless there is a particular remark otherwise stated. Also, in the drawings hereinafter, illustrations of the structure surrounding the core 15 of the delivery fiber 7 will be omitted.

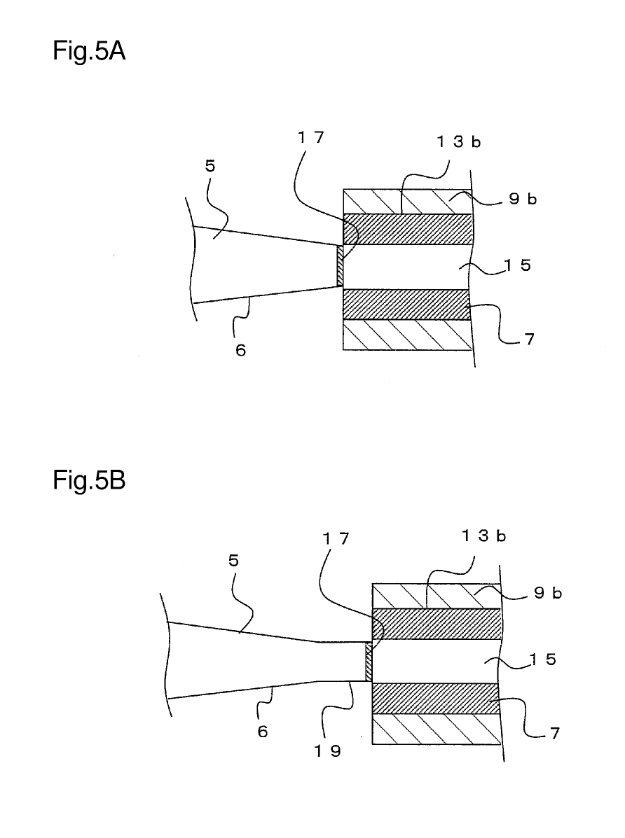

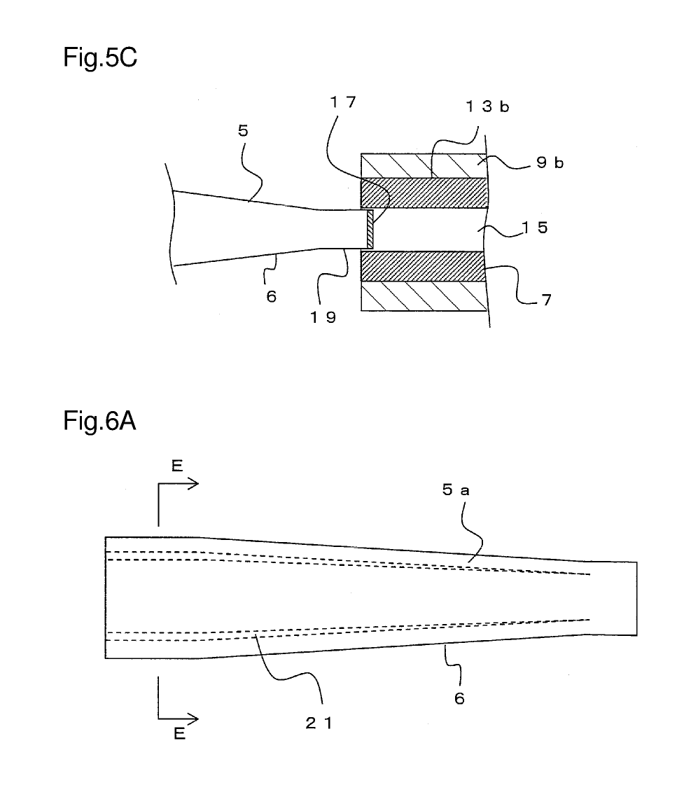

FIG. 5A is an enlarged view showing an optical connection part between the tapered waveguide 5 and the delivery fiber 7. If the core 15 is hollow, it is preferable that an antireflection film 17 is provided on an emission end surface of the tapered waveguide 5. The antireflection film 17 is a film made of magnesium fluoride (MgF₂) or zirconium dioxide (ZrO₂), for example. As shown in the drawing, disposing and aligning an end surface position of the small-diameter side of the tapered waveguide 5 to an end surface position of the delivery fiber 7 allows the light emitting from the tapered waveguide 5 to be introduced into the core 15.

Also, as shown in FIG. 5B, a straight part 19 of a predetermined length with a substantially uniform diameter may be formed in proximity of the end part on the small-diameter side of the tapered waveguide 5. For example, the tapered waveguide 5 has the straight part 19, of which the outer diameter does not substantially change, in proximity of each of the end surfaces of the large-diameter and small-diameter sides thereof. In such a case, the tapered part 6 whose outer diameter changes at a constant rate is formed between the straight parts 19.

Also, as shown in FIG. 5C, a part of the straight part 19 in proximity of the end part on the small-diameter side of the tapered waveguide 5 may be inserted into the core 15 of the delivery fiber 7, which is a hollow core fiber. In such a case, an outer side face of the straight part 19 of the tapered waveguide 5 and an inner side face of the core 15 may be in contact with each other. This enables to stabilize the position of the tapered waveguide 5 and prevents leaking of light. If a laser beam of light with high power and a short wavelength, such as green, blue, or ultraviolet light, is used, leaking of light may cause heat generation due to absorption by resin-made adhesive or the like, and thus it is particularly effective to use the presently described embodiments in such cases to prevent leaking of light.

If the delivery fiber 7 is a common optical fiber, then the tapered waveguide 5 and the delivery fiber 7 can be optically connected by fusion or bonding, as in the optical connection between the optical fiber bundle part 3 and the tapered waveguide 5.

As shown in FIG. 1, the capillaries 9a and 9b are fixed to the retaining member 11 respectively in a state in which the optical fiber bundle part 3, the tapered waveguide 5, and the delivery fiber 7 are disposed on the same axis and optically connected to each other. As shown in FIG. 2A to FIG. 2C, the V-shaped groove is formed in the retaining member 11 and the capillaries 9a and 9b are disposed in and fixed to the V-shaped groove. That is, the capillaries 9a and 9b have the same diameter.

On the other hand, the outer diameter of the tapered waveguide 5 is smaller than the outer diameter of the capillaries 9a and 9b. Thus, the tapered waveguide 5 is held floating above the retaining member 11 and the outer side face of the tapered waveguide 5 is not in contact with the retaining member 11. That is, the tapered waveguide 5 is not in contact with any other solid structures and there is an air layer formed therearound.

Here, if the tapered waveguide 5 has a uniform refractive index, the air existing on the outer circumference of the side face of the tapered waveguide 5 serves as an air clad. In general, gas such as air has a refractive index that is sufficiently smaller than that of glass or the like, so the difference between the refractive index of the tapered waveguide 5 and the refractive index of the gas enveloping the outer side face of the tapered waveguide 5 becomes larger. For this reason, it is possible to make the numerical aperture of the tapered waveguide 5 (NAₜₐₚₑᵣ [symbol] 1) larger than the numerical aperture of the delivery fiber 7 (NA_{delivery} [symbol] 0.7). Thus, light can be coupled to the delivery fiber 7 to the limit.

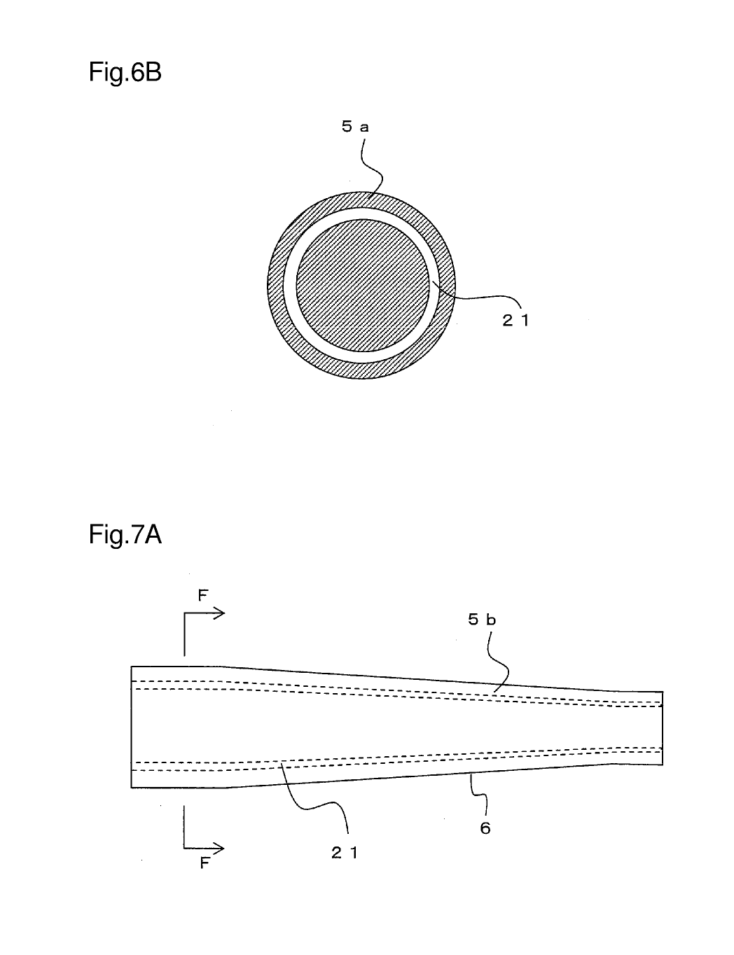

The tapered waveguide 5 may not necessarily be formed with only the uniform refractive index. FIG. 6A shows a tapered waveguide 5a and FIG. 6B is a cross sectional view taken along E-E line in FIG. 6A. A substantially circular-shaped air-clad 21 is formed on at least a part of an interior of the tapered waveguide 5a. The air-clad 21 is formed continuously from an end surface on a large-diameter side to proximity of an end surface on a small-diameter side. A diameter of the air-clad 21 gradually decreases toward the end part on the small-diameter side according to the outer diameter change of the tapered part 6 of the tapered waveguide 5a. The air-clad 21 is not formed on the end part on the small-diameter side of the tapered waveguide 5a and a cross section thereof is completely solid.

In this case, light from the optical fiber bundle part 3 is introduced into a solid part inside the air-clad 21. That is, a section surrounded by the air-clad 21 serves as a core (hereinafter, the section surrounded by the air-clad 21 will be simply referred to as a core section). After the diameter of the air-clad 21 is decreased on the end part on the small-diameter side and the light is no longer contained in the core section, an air layer around the tapered waveguide serves as an air-clad and prevents leaking of light to outside of the tapered waveguide. In this way, a greater numerical aperture can be obtained. Also, it is possible to prevent leaking of light or heat generation caused by dust or the like attaching to an outer circumference surface of the core part. In particular, it is further more effective in preventing leaking of light or heat generation when high power and short-wavelength laser beams such as green, blue, or ultraviolet light are used.

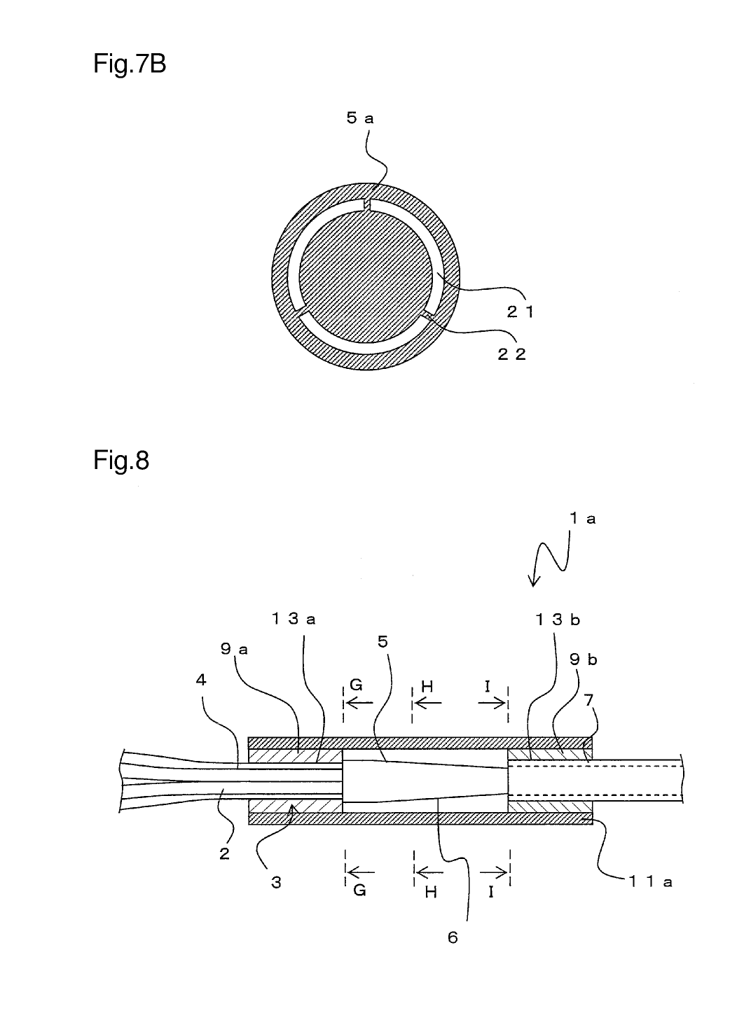

FIG. 7A shows a tapered waveguide 5b and FIG. 7B is a cross sectional view taken along F-F line in FIG. 7A. The tapered waveguide 5b has the air-clad 21 formed over the entire length of the tapered waveguide 5b. In this case, supporting parts 22 join the core section and an outer circumference part surrounding the core section. For example, the supporting parts 22 are provided at predetermined intervals on the outer circumference part of the core section in a circumferential direction, and joining the core section and the outer circumference part surrounding the core section by the supporting parts 22 can keep the gaps (the air-clad 21) between the core section and the outer circumference part surrounding the core section.

Here, making a thickness of the supporting part 22 less than a wavelength of the light transmitting the core section can prevent leaking of light from the supporting parts 22 even if the supporting parts 22 exist.

Although illustrations are omitted, a solid tapered waveguide having a core and a clad surrounding the core may also be used. In this case, the tapered waveguide can be formed by heating and melting an optical fiber.

Also, instead of a step index type refractive index profile in which the refractive index varies at an interface between the core and the clad, the tapered waveguide may have a graded index type refractive index profile in which the refractive index continuously varies. In this way, the light inside the tapered waveguide can be concentrated onto the center of the tapered waveguide.

If the tapered waveguide is solid inside having a core and a clad, the difference between the refractive index of the core and that of the clad is smaller than the difference between the refractive index of the core section and that of the air clad in the case of the tapered waveguide having the above-mentioned air-clad 21. For this reason, light may leak out to the clad. However, the air layer around the tapered waveguide serves as the air clad and prevents the light leaked to the clad from leaking outside the tapered waveguide. Thus, the tapered waveguide can transmit light efficiently from the optical fiber bundle part 3 to the delivery fiber 7.

As above, according to the present embodiment, the optical fiber bundle part 3 and the delivery fiber 7 are fixed to the capillaries 9a and 9b, which are fixed to the retaining member 11. Also, the tapered waveguide 5 is joined with the optical fiber bundle part 3. Thus, the optical fiber bundle part 3, the tapered waveguide 5, and the delivery fiber 7 can be fixed while being optically connected.

Also, at this state, the outer side face of the tapered waveguide 5 is not in contact with the retaining member 11 or any other solid structures. That is, an air layer is formed over the entire outer side face of the tapered waveguide 5. Thus an outer circumference of the tapered waveguide 5 can serve as an air clad. This can increase the difference between the refractive index of the material forming the tapered waveguide 5 and the refractive index of the air, and can increase the numerical aperture of the tapered waveguide 5. Thus, greater power light can be optically connected to the delivery fiber 7 with a minimum loss of light.

Also, since the optical fiber bundle part 3 is in the bundle structure 4, the optical fibers 2 can be arranged in the maximum dense way. Thus, light can be efficiently introduced into the tapered waveguide 5.

Also, instead of the tapered waveguide 5 that has the substantially uniform refractive index overall, the same effects can be obtained by using the tapered waveguide 5a or 5b, which has the air-clad 21 therein. Also, in this case, it is possible to prevent the core section from attaching of dust or the like.

Also, using the tapered waveguide having a graded index type refractive index profile can concentrate light transmitting the tapered waveguide onto the center. This can reduce effects of dust or the like attached to the outer side face of the tapered waveguide, for example.

Also, if the delivery fiber 7 having the core 15 is a hollow core fiber having a hollow core, the numerical aperture of the delivery fiber 7 can be increased. Also, forming the straight part 19 in proximity of the end part on the small-diameter side of the tapered waveguide 5 and inserting a part of a tip end of the straight part 19 into the hollow core can prevent misalignment of axes of the delivery fiber 7 and the tapered waveguide 5 or the like.

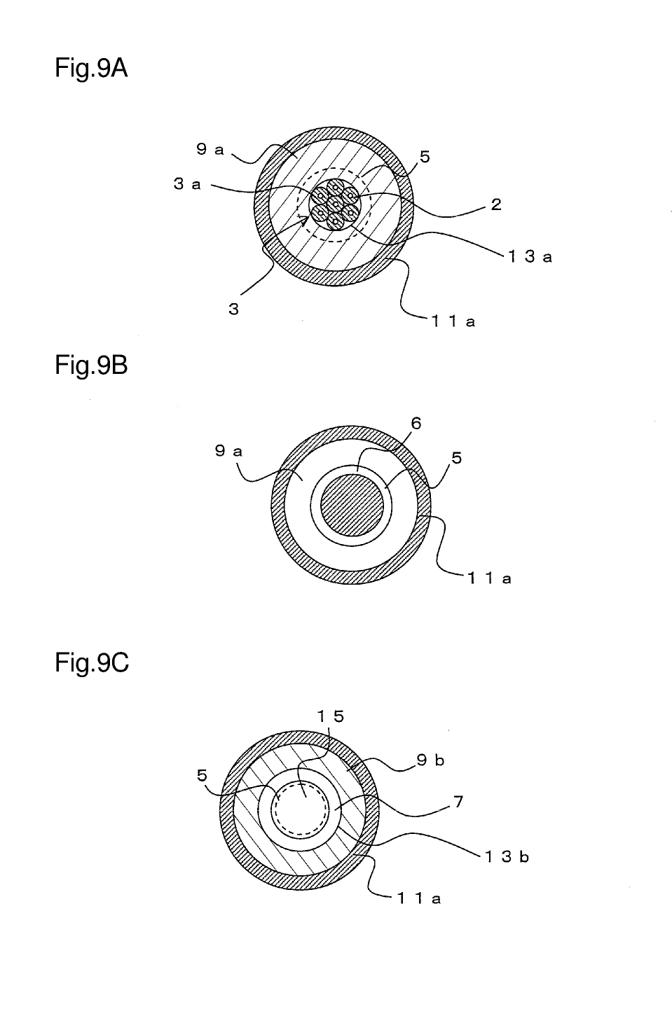

Next, a second embodiment will be described. FIG. 8 is a schematic view showing an optical connection structure 1a according to the second embodiment. FIG. 9A is a cross sectional view taken along G-G line in FIG. 8, FIG. 9B is a cross sectional view taken along H-H line in FIG. 8, and FIG. 9C is a cross sectional view taken along I-I line in FIG. 8. In the descriptions hereinafter, the same notations as in FIG. 1 to FIG. 7 will be used for the structures having the same functions as in the optical connection structure 1, and redundant descriptions will be omitted. Also, in the descriptions below, although an example to which the tapered waveguide 5 is applied will be described, the tapered waveguide 5a or 5b may also be applied.

The optical connection structure 1a has almost the same structure as the optical connection structure 1 except that a retaining member 11a is used therein. The retaining member 11a is a substantially cylindrical member. The retaining member 11a may have a slit along a longitudinal direction thereof.

The capillaries 9a and 9b are fixed inside the retaining member 11a. As mentioned above, the outer diameter of the tapered waveguide 5 is smaller than the outer diameter of the capillaries 9a and 9b, and thus the retaining member 11a and the tapered waveguide 5 are not in contact with each other. That is, the retaining member 11a envelops the outer side face of the tapered waveguide 5 with a space therebetween.

According to the second embodiment, the same effects can be obtained as in the first embodiment. Also, since the retaining member 11a envelops the outer side face of the tapered waveguide 5, it is possible to prevent leaking of light or heat generation caused by dust or the like attaching to the outer side face of the tapered waveguide 5. In particular, it is further more effective in preventing leaking of light or heat generation when high power and short-wavelength laser beams such as green, blue, or ultraviolet light are used.

If the retaining member 11a is in a complete cylindrical shape without a slit part and envelops the entire circumference of the tapered waveguide 5, entry of foreign substances into the retaining member 11a can be prevented with certainty since both ends of the retaining member 11a are blocked by the capillaries 9a and 9b. Also, in this case, instead of air, a fluid such as liquid like water or other gas can be enclosed in the space between the tapered waveguide 5 and the retaining member 11a. For example, liquid such as water can enhance cooling effect of the tapered waveguide 5.

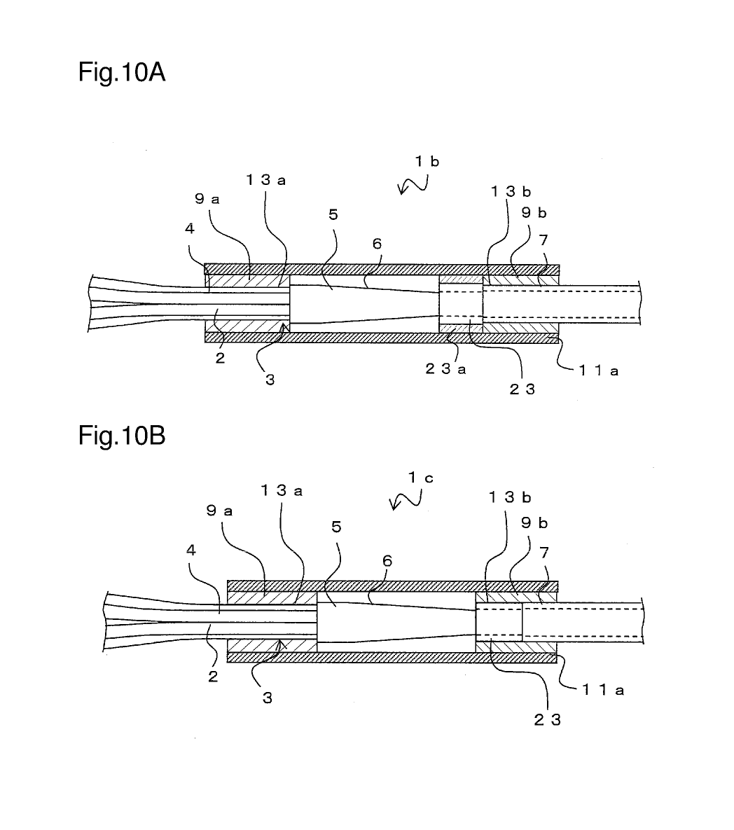

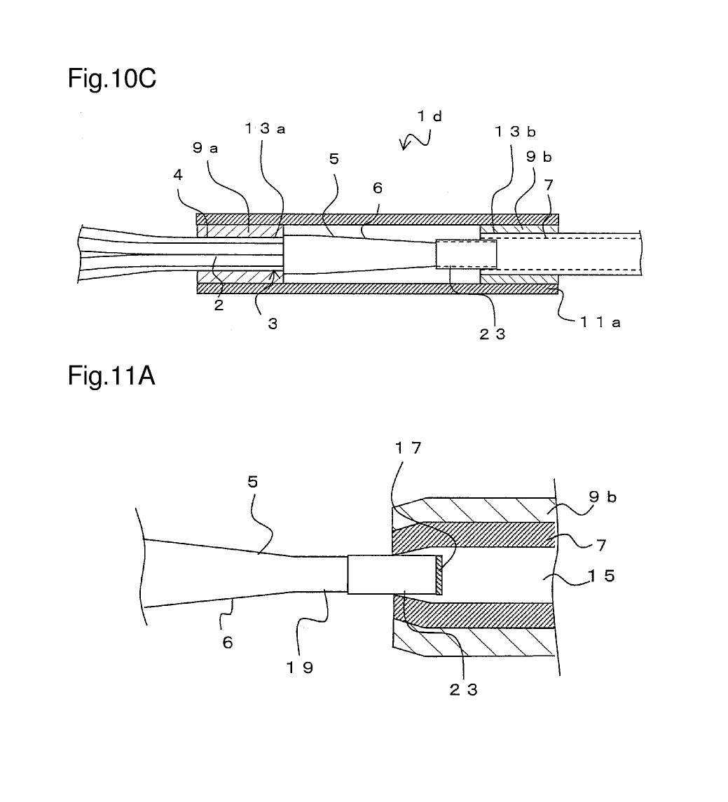

Next, a third embodiment will be described. FIG. 10A is a schematic view showing an optical connection structure 1b according to the third embodiment. The optical connection structure 1b has almost the same structure as the optical connection structure 1a except that an intermediary fiber 23 is used therein.

The tapered waveguide 5 and the delivery fiber 7 are optically connected with the intermediary fiber 23 therebetween. That is, one end part of the intermediary fiber 23 is optically connected with the end surface on the small-diameter side of the tapered waveguide 5. Also, another end part of the intermediary fiber 23 is optically connected with the end surface of the delivery fiber 7 (the core 15). The intermediary fiber 23 includes a core and a clad enveloping the core, and a core diameter of the intermediary fiber 23 is larger than the outer diameter of the small-diameter side of the tapered waveguide 5 and smaller than the core diameter of the delivery fiber 7.

The intermediary fiber 23 may have an air clad. In such a case, for example, the supporting parts 22 may join an inner face side and an outer face side of the air clad as shown in a cross sectional shape in FIG. 7B.

The intermediary fiber 23 is fixed to a capillary 23a. Both end surfaces of the intermediary fiber 23 are exposed to both end surfaces of the capillary 23a. That is, the intermediary fiber 23 and the capillary 23a are so-called stubs. The capillary 23a has the same diameter as the capillary 9a or 9b and is joined and fixed to the retaining member 11a.

As mentioned above, to introduce light efficiently from the optical fiber bundle part 3 to the delivery fiber 7, it is preferable to set the numerical apertures as follows: the numerical aperture of the tapered waveguide 5>the numerical aperture of the intermediary fiber 23>the numerical aperture of the delivery fiber 7. For example, if the numerical aperture of the tapered waveguide 5 is approximately 0.95 and numerical aperture of the intermediary fiber 23 is approximately 0.8, then the numerical aperture of the delivery fiber 7 should be approximately 0.7.

The tapered waveguide 5 and the intermediary fiber 23 are connected by fusion or with an adhesive agent, for example. Also, the delivery fiber 7 (the capillary 9b) and the intermediary fiber 23 (the capillary 23a) are connected by fusion or with an adhesive agent, for example. If the delivery fiber 7 is a hollow core fiber, the antireflection film 17 is formed on the end surface of the intermediary fiber 23 that faces the delivery fiber 7.

The optical connection structure 1b is manufactured as below, for example. First, the optical fiber bundle part 3 (the bundle structure 4) is fixed to the capillary 9a. Similarly, the intermediary fiber 23 is fixed to the capillary 23a. Next, the polished end surfaces of the optical fiber bundle part 3 and the tapered waveguide 5 are optically connected with each other. Similarly, the polished end surfaces of the intermediary fiber 23 and the tapered waveguide 5 are optically connected with each other.

Next, these are inserted into the retaining member 11a to fix the capillaries 9a and 23a to the retaining member 11a. Finally, the delivery fiber 7 that is fixed to the capillary 9b is inserted into the retaining member 11a, optically connecting the delivery fiber 7 with the intermediary fiber 23 and fixing the capillary 9b to the retaining member 11a. As above, the optical connection structure 1b can be obtained.

Compared to the direct optical connection of the tapered waveguide 5 and the delivery fiber 7, using the intermediary fiber 23 as above facilitates manufacturing the optical connection structure. In particular, when the delivery fiber 7 is a hollow core fiber, it is difficult to perform optical axis alignment between the end part on the small-diameter side of the tapered waveguide 5 and the core 15 of the delivery fiber 7 inside the retaining member 11a. However, using the intermediary fiber 23 can facilitate this operation.

An optical connection structure using the intermediary fiber 23 may be realized as an optical connection structure 1c shown in FIG. 10B. The optical connection structure 1c has almost the same structure as the optical connection structure 1b except that a way in which the intermediary fiber 23 is retained is different.

In the optical connection structure 1c, the intermediary fiber 23 is fixed to the capillary 9b, which retains the delivery fiber 7. That is, the outer diameters of the intermediary fiber 23 and the delivery fiber 7 are substantially the same. One of the end surfaces of the intermediary fiber 23 is exposed to the end part of the capillary 9b. The other end surface of the intermediary fiber 23 is optically connected with the delivery fiber 7 inside the capillary 9b. The optical connection between the tapered waveguide 5 and the intermediary fiber 23 and the optical connection between the intermediary fiber 23 and the delivery fiber 7 are the same as in the optical connection structure 1b.

The optical connection structure 1c is manufactured as below, for example. First, the optical fiber bundle part 3 (the bundle structure 4) is fixed to the capillary 9a. Similarly, the intermediary fiber 23 and the delivery fiber 7 are optically connected and fixed to the capillary 9b. Next, the polished end surfaces of the optical fiber bundle part 3 and the tapered waveguide 5 are optically connected with each other. Similarly, the polished end surfaces of the intermediary fiber 23 and the tapered waveguide 5 are optically connected with each other.

Next, these are inserted into the retaining member 11a and the capillaries 9a and 9b are fixed to the retaining member 11a. As above, the optical connection structure 1c can be obtained. Compared to optical axis alignment between the hollow core of the delivery fiber 7 and the end part on the small-diameter side of the tapered waveguide 5 inside the retaining member 11a, using the intermediary fiber 23 as above facilitates the operation.

Also, another optical connection structure using the intermediary fiber 23 may be realized as an optical connection structure 1d shown in FIG. 10C. The optical connection structure 1d has almost the same structure as the optical connection structure 1b except that a way in which the intermediary fiber 23 is retained is different.

In the optical connection structure 1d, the intermediary fiber 23 is not fixed to a capillary and is connected to an end part on the small-diameter side of the tapered waveguide 5 by fusion or bonding. In the present embodiment, a part of a tip end of the intermediary fiber 23 is inserted into the hollow core of the delivery fiber 7, which is a hollow core fiber. The tip end of the intermediary fiber 23 may be inserted into and optically connected to the core 15 of the delivery fiber 7 in this way.

According to the third embodiment, the same effects as in the first embodiment can be obtained. Also, using the intermediary fiber 23 facilitates manufacturing the optical connection structure.

If the delivery fiber 7 is a hollow core fiber and a part of the tip end of the tapered waveguide 5 or the intermediary fiber 23 is inserted therein, the diameter of the end part of the delivery fiber 7 may be reduced.

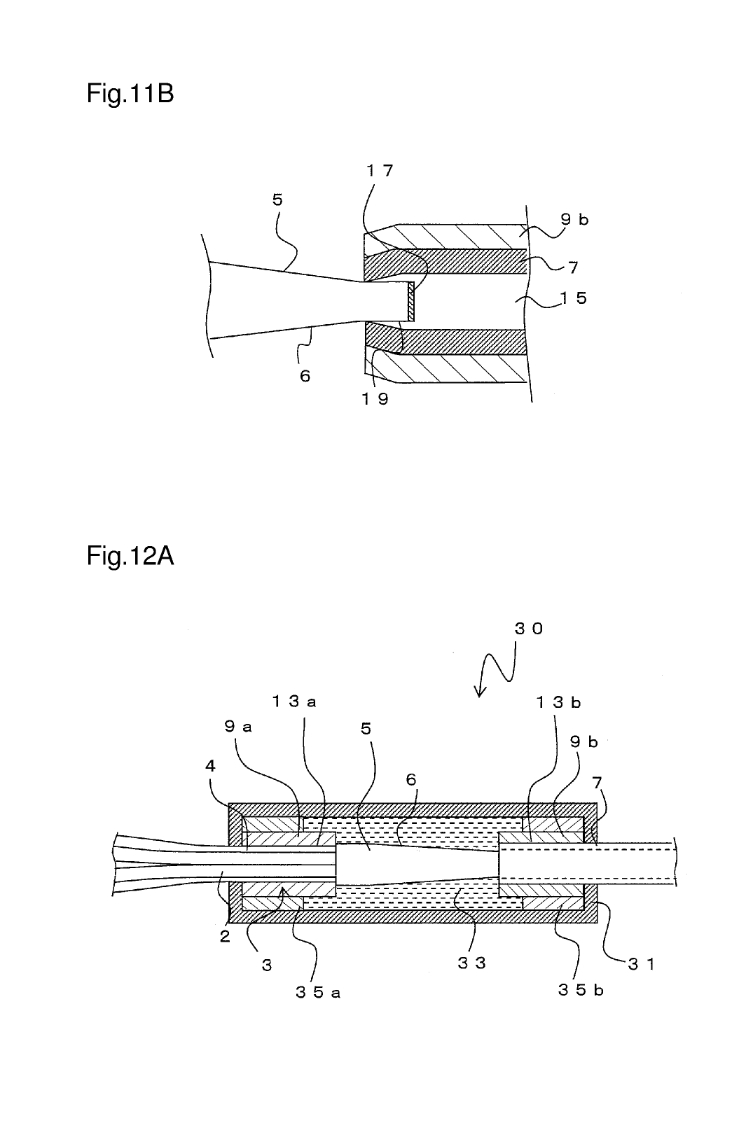

FIG. 11A is a view showing a state in which the tip end of the intermediary fiber 23 is inserted into the core 15 of the delivery fiber 7 as in the optical connection structure 1d. When the outer diameter of the intermediary fiber 23 is large enough in regard to the core 15, the tip end position of the intermediary fiber 23 may become unstable inside the core 15. For this reason, with the tip end of the intermediary fiber 23 being inserted into the delivery fiber 7, the diameters of the end parts of the delivery fiber 7 and the capillary 9b may be reduced and the delivery fiber 7 and the intermediary fiber 23 may be fused. In this way, the end part of the delivery fiber 7 can retain the end part of the intermediary fiber 23.

Also, such a structure can be applied to a case without using the intermediary fiber 23, which is shown in FIG. 11B, in which a tip end of the straight part 19 on the end part on the small-diameter side of the tapered waveguide 5 is inserted into the delivery fiber 7. That is, with the tip end of the straight part 19 being inserted into the delivery fiber 7, the diameters of the end parts of the delivery fiber 7 and the capillary 9b may be reduced and the delivery fiber 7 and straight part 19 are then be fused. In this way, the end part of the delivery fiber 7 can retain the end part of the straight part 19.

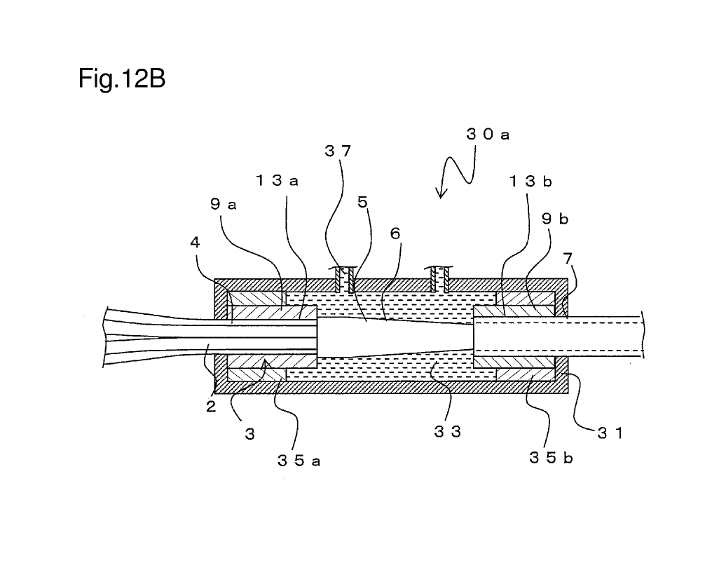

Next, a fourth embodiment will be described. FIG. 12A is a view showing an optical module 30. The optical module 30 includes the optical fiber bundle part 3, the tapered waveguide 5, the delivery fiber 7, the capillaries 9a and 9b, holding members 35a and 35b, a housing 31, and so on. That is, the optical module 30 accommodates a part of the structure of the above-mentioned optical connection structure including the tapered waveguide 5 within the housing 31.

The capillary 9a is held by the substantially cylindrical holding member 35a and fixed. The capillary 9b is held by the substantially cylindrical holding member 35b and fixed. The holding members 35a and 35b have approximately the same outer diameters. The holding members 35a and 35b are joined and fixed to an inner face of the housing 31. That is, the capillaries 9a and 9b are fixed to the housing 31 by means of the holding members 35a and 35b respectively. Instead of using the holding members 35a and 35b, the capillaries 9a and 9b may be fixed directly to the housing 31.

As mentioned above, the outer diameter of the tapered waveguide 5 is smaller than the outer diameters of the capillaries 9a and 9b. Thus, the outer side face of the tapered waveguide 5 is not in contact with the inner face of the housing 31, and the outer side face of the tapered waveguide 5 is not in contact with any other solid structures.

Fluid 33 is enclosed in a space between the outer side face of the tapered waveguide 5 and the inner face of the housing 31. The fluid 33 may be a gas such as air, nitrogen, and argon, or may be a liquid such as pure water. A gas or a liquid has a sufficiently smaller refractive index than the glass-made tapered waveguide 5, for example, and this can increase the numerical aperture of the tapered waveguide 5.

Alternatively, instead of enclosing the fluid 33 inside the housing 31, the interior of the housing 31 may be evacuated to make it a vacuum. This can also prevent the tapered waveguide 5 from being in contact with the other solid structures and can increase the numerical aperture of the tapered waveguide 5.

The holding members 35a and 35b are made of metal or glass, for example. If the holding members 35a and 35b are made of glass, the capillaries 9a, 9b and the holding members 35a and 35b are fixed by welding using CO₂ laser or by bonding, for example. Also, if the holding members 35a and 35b are made of metal, the capillaries 9a, 9b and the holding members 35a and 35b are fixed by welding using YAG laser or by bonding, for example.

Also, the housing 31 is made of metal, for example. In such a case, the holding members 35a, 35b and the housing 31 are fixed by welding using CO₂ laser or YAG laser or by bonding, for example. The holding members 35a and 35b may be made of resin with high viscosity (such as silicon) or rubber.

Here, after fixing the capillaries 9a, 9b, the holding members 35a, 35b, the housing 31, and the like to each other, a laser beam or the like may be irradiated onto a part thereof to deform a member. For example, after fixing every member, for the optical axis alignment, fine adjustment can be made to the arrangements of each member or the like by irradiating laser onto the holding members 35a and 35b or the like, which will be deformed, to finely adjust the positions and directions of the members such as capillaries 9a and 9b and the tapered waveguide 5.

Also, if the fluid 33 is enclosed inside the housing 31, a fluid channel 37 may be connected to the housing 31 as in an optical module 30a shown in FIG. 12B. The fluid channel 37 interconnects the inside and outside of the housing 31, and, for example, a pair of the fluid channels 37 for an entry side and an exit side is formed. The fluid channel 37 is connected to a pomp or the like whose illustration is omitted and can circulate the fluid 33 within the housing 31. This enables to perform cooling of the optical connection structure within the housing 31.

According to the fourth embodiment, the same effects as in the first embodiment can be obtained. Also, since the optical connection structure is accommodated within the housing 31, it is possible to prevent the outer side face of the tapered waveguide 5 from attaching of dust or the like. Also, the housing 31 can protect the optical connection structure inside.

Also, enclosing and circulating a fluid inside can cool down the optical connection structure therein.

Although the embodiments have been described referring to the attached drawings, the technical scope of the present disclosure is not limited to the embodiments described above. Persons skilled in the art can think out various examples of changes or modifications within the scope of the technical idea recited by the claims, and it will be understood that they naturally belong to the technical scope of the present disclosure.

What is claimed is:

1. An optical connection structure, comprising:
a tapered waveguide having a tapered part, an outer diameter of the tapered part being changed in a tapered shape;
an optical fiber bundle part formed by assembling together a plurality of optical fibers, the optical fiber bundle part being optically connected to an end surface on a large-diameter side of the tapered waveguide; and
a delivery fiber being optically connected with an end surface on a small-diameter side of the tapered waveguide, wherein
the optical fiber bundle part and the delivery fiber are fixed to capillaries respectively;
each of the capillaries is fixed to a retaining member; and
an outer side face of the tapered waveguide is not in contact with the retaining member.

2. The optical connection structure according to claim 1, wherein the retaining member is a substantially cylindrical member, which envelops the outer side face of the tapered waveguide with a space therebetween.

3. The optical connection structure according to claim 1, wherein the optical fiber bundle part is in a bundle structure in which a plurality of optical fibers are bundled.

4. The optical connection structure according to claim 1, wherein the entire tapered waveguide is formed with a substantially uniform refractive index.

5. The optical connection structure according to claim 1, wherein an air clad is provided on at least a part of an interior of the tapered waveguide.

6. The optical connection structure according to claim 1, wherein the tapered waveguide includes a core and a clad enveloping the core.

7. The optical connection structure according to claim 1, wherein the tapered waveguide has a graded index type refractive index profile.

8. The optical connection structure according to claim 1, wherein the delivery fiber is a hollow core fiber.

9. The optical connection structure according to claim 8, wherein the hollow core fiber is a hollow core PBGF (Photonic Band Gap Fiber).

10. The optical connection structure according to claim 9, wherein the hollow core PBGF is a Kagome fiber.

11. The optical connection structure according to claim 8, wherein a straight part having a predetermined length and a substantially uniform diameter is formed in proximity of the small-diameter side of the tapered waveguide, and a part of the straight part is inserted into the hollow core fiber.

12. The optical connection structure according to claim 1, wherein the tapered waveguide and the delivery fiber are optically connected with an intermediary fiber therebetween.

13. The optical connection structure according to claim 12, wherein the delivery fiber is a hollow core fiber and a part of the intermediary fiber is inserted into the hollow core fiber.

14. An optical module comprising:
a tapered waveguide having a tapered part, an outer diameter of the tapered part being changed in a tapered shape;
an optical fiber bundle part formed by assembling together a plurality of optical fibers, the optical fiber bundle part being optically connected to an end surface on a large-diameter side of the tapered waveguide;
a delivery fiber being optically connected with an end surface on a small-diameter side of the tapered waveguide; and
a housing accommodating the tapered waveguide, wherein:
the optical fiber bundle part and the delivery fiber are fixed to capillaries respectively;
each of the capillaries is fixed to the housing;
an outer side face of the tapered waveguide is not in contact with the housing; and
a fluid is enclosed inside the housing or an inside of the housing is in a vacuum state.

15. The optical module according to claim 14, wherein a fluid channel is connected to the housing, the fluid channel allowing fluid to circulate inside the housing.

16. The optical module according to claim 14, wherein a holding member holds each of the capillaries and the holding member is joined to an inner face of the housing.
